(19) United States
(12) Patent Application Publication
(10) Pub. No.: US 2004/0139205 A1
(43) Pub. Date: Jul. 15, 2004

(54) Hot standby server system

(76) Inventors: Masaya Ichikawa, Sagamihara (JP); Hideaki Sampei, Tokyo (JP); Toshiyuki Ukai, Tokyo (JP); Takaaki Haruna, Tokyo (JP); Kenta Ninose, Yokohama (JP); Yuzuru Maya, Sagamihara (JP)

Correspondence Address: MATTINGLY, STANGER & MALUR, P.C., ATTORNEYS AT LAW, 1800 DIAGONAL ROAD, SUITE 370, ALEXANDRIA, VA, 22314, US

(21) Appl. No.: 10/608,010

(22) Filed: Jun. 30, 2003

(30) Foreign Application Priority Data
Sep. 12, 2002 (JP) 2002-266206

(51) Int. Cl. G06F 15/16

(52) U.S. Cl. 709/229; 713/201

(57) ABSTRACT

A server system comprising a plurality of servers that can be each operated as a primary system and a standby system by system switching, and a shared disk unit for storing data accessed by said plurality of servers, wherein: each of said plurality of servers comprises: an application means; a driver means that: acquires information on a configuration inside said shared disk unit after starting of said system; and, based on said configuration information, sets said shared disk unit in an active state in which an access request to said shared disk unit can be sent; and, when the driver means receives an access request to said shared disk unit, sends said access request to said shared disk unit; and an access control means that: judges whether an access request issued by said application means should be sent, based on a management table indicating inhibited types of access requests for each access destination; and sends said access request to said driver means when said access request is not inhibited for an access destination of said access request. By this arrangement, hot standby switching processing can be performed at high speed.

### BACKGROUND OF THE INVENTION

1. Field of the Invention

The present invention relates to a hot standby system comprising a primary server, a standby server and a disk unit shared by the primary and standby servers, and to a high speed switching system for the shared disk unit.

2. Related Art Statement

In the field of online transactions, availability is enhanced by employing a hot standby system configuration comprising a primary server, a standby server and a shared disk unit.

A hot standby switching procedure in the conventional hot standby system is described as follows.

Namely, when a fault is detected in a primary server, a standby server issues an activation command to a device driver on the standby server so that it becomes possible to issue an access request to a shared disk unit. When an activation command is issued, the device driver requests disk configuration information (i.e., information on a configuration inside the disk) and performance information to the shared disk unit. Then, based on the received disk configuration information and the like, a map for specifying areas within a physical disk is generated for each logical volume, in order to reserve the shares disk.

As a hot standby switching technique in the conventional hot standby system, Japanese Non-examined Patent Laid-Open No. H10-289122 may be mentioned.

### SUMMARY OF THE INVENTION

As described above, in the conventional hot standby switching technique, the standby server receives disk configuration information and the like from the shared disk unit after a fault is detected, and then, reserves the disk based on the received information.

Accordingly, a hot standby switching process takes a long time, and sometimes there occurs a state of waiting for execution of an application, a state of delay in processing, or the like. Further, if access by the faulty server occurs, consistency uf data may be spoiled.

An object of the present invention is to provide a technique of executing a hot standby switching process at high speed.

To solve the above problems, an embodiment of the present invention provides a server system comprising a plurality of servers that can be each operated as a primary system and a standby system by system switching, and a shared disk unit for storing data accessed by said plurality of servers, wherein:

each of said plurality of servers comprises:

an application means;

a driver means that: acquires configuration information inside said shared disk unit after starting of said system; and, based on said configuration information, sets said shared disk unit in an active state in which an access request to said shared disk unit can be sent; and, when the driver means receives an access request to said shared disk unit, sends said access request to said shared disk unit; and

an access control means that: judges whether an access request issued by said application means should be sent, based on a management table indicating inhibited types of access requests for each access destination; and sends said access request to said driver means when said access request is not inhibited for an access destination of said access request.

Further, in the above embodiment, it is favorable that, when a fault occurs in the primary server, then the access control means of the server registers in the management table such that an access request of an executed application program to any access destination is inhibited.

Further, in the above embodiment, it is favorable to provide a console for sending the servers a system switching command inputted by an operator. Further, it is favorable that, when a server operates as the primary system and the access control means of the server receives a system switching command, then, the access control means registers in the management table such that an access request of an executed application means to any stress destination is inhibited

Further, favorably, the access control means registers in the management table such that, as the above-mentioned access request, at least write is inhibited.

Further, in the above embodiment, favorably, the management table indicates an inhibited read and/or write access request for each access destination. Further, it is favorable that the access control means judges, based on the management table, whether a read or write access request issued by the application means should be sent, and sends the read or write access request to the driver means when the access request is directed to an access destination for which the mentioned read or write access request is not inhibited.

Further, in the above embodiment, favorably, the management table indicates an inhibited file open and/or file close access request for each access destination. Further, it is favorable that the access control means judges, based on the management table, whether a file open or file close access request issued by the application means should be dent, and sends the file open or file close access request to the driver means when the access request is directed to an access destination for which the mentioned file open or file close access request is not inhibited.

Further, it is favorable that the server system further comprises a console for sending the servers a command for registering, deleting or changing inhibited access requests for each access destination. Here, an operator inputs the command. Further, it is favorable that, when the access control means receives the commands, then, according to said command, the access control means registers, deletes or changes an access destination ID and types of access requests inhibited for the access destination, in the management table.

Further, in the above embodiment, it is favorable that the server system further comprises a console for sending a command that requests contents of the management table, to a server, and for outputting the contents of the management table received from the server. Here, an operator inputs the command.

### BRIEF DESCRIPTION OF THE DRAWINGS

FIG. 1 is a block diagram showing a configuration of a server system as an embodiment of the present invention;

FIG. 2 is a block diagram showing a configuration of an access control unit;

FIG. 3 is a diagram showing a configuration of a shared disk;

FIG. 4 is a volume state transition diagram;

FIG. 5 is a schematic diagram showing access request input/output processing in an embodiment of the present invention;

FIG. 6 is a flowchart showing hot standby processing at the time of a fault in an embodiment of the present invention;

FIG. 7 is a flowchart showing hot standby processing by console input in an embodiment of the present invention;

FIG. 8 is a diagram showing contents of a device switch table; and

FIG. 9 is a diagram showing contents of a management table.

### DETAILED DESCRIPTION OF THE PREFERRED EMBODIMENTS

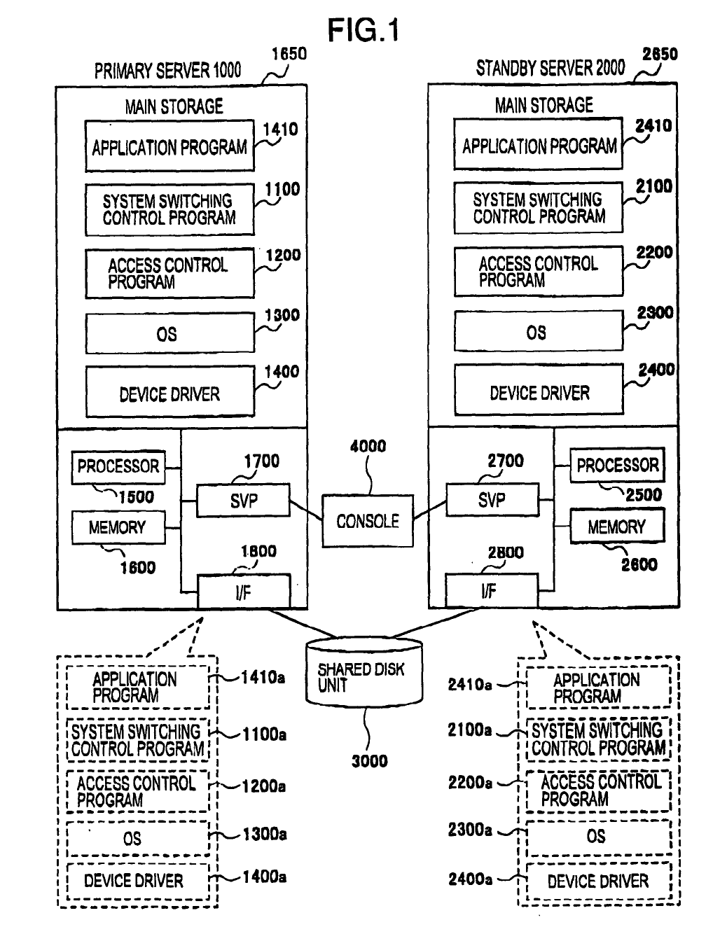

FIG. 1 is a block diagram showing a configuration of a server system as an embodiment of the present invention.

This server system comprises a primary server 1000, a standby server 2000, a shared disk unit 3000, and a console 4000.

The primary server 1000 and the standby server 2000 each comprise a processor 1500, 2500, a memory 1600, 2600, an SVP (Service Processor) 1700, 2700, an input-output interface (hereinafter, referred to as I/F) 1800, 2800, and a main storage 1650. 2650.

Each main storage 1650, 2650 stores a system switching control program 1100, 2100, an access control program 1200, 2200, an OS (Operating System) 1300, 2300, and a device driver 1400, 2400.

When each of the processors 1500, 2500 executes these programs loaded onto the memory 1600, 2600, an application program 1410a, 2410a, a system switching control program 1100a, 2100a, an access control program 1200a, 2200a, an OS 1300a, 2300a, and a device driver 1400a, 2400a are constructed virtually on each of the primary server 1000 and the standby server 2000.

The shared disk unit 3000 stores data to be accessed by an application program 1410a, 2410a of the primary server 1000 or the standby server 2000. Such data are stored by one volume or a plurality of volumes. Here, “volume” may be a physical unit such as a physical disk or may be a logical unit such as a file.

The console 4000 is connected with the SVPs 1700, 2700, and receives a command inputted by an operator, and issues the command to a certain unit within the server 1000 or 2000 according to the received command.

Here, for each server 1000 or 2000, the system switching control program 1100, 2100, the access control program 1200, 2200, the OS 1300, 2300 and the device driver program 1400, 2400 are stored in a storage medium such as a CD-ROM, and then, stored in the main storage 1650, 2650. Thereafter, those programs are loaded onto the memory 1600, 2600 and executed by the processor 1500, 2500 to construct the above-mentioned units, respectively. Here, a part or all of the switching control program 1100, 2100, the access control program 1200, 2200 and the device driver program 1400, 2400 may be included in the OS 1300, 2300.

The medium for storing the programs may be a storage medium other than the CD-ROM. Further, the programs may be loaded onto the memory 1600, 2600 from the storage medium. Or, the storage medium may be accessed through a network in order to load the programs onto the memory 1600, 2600. Further, the system switching control program 1100a, 2100a, the access control program 1200a, 2200a, the OS 1300a, 2300a, and the device driver 1400a, 2400a may be implemented separately from the primary server 1000 or the standby server 2000.

Each of the system switching control programs 1100a, 2100a detects a fault in the primary server 1000 or the standby server 2000, and makes an instruction to perform the below-mentioned hot standby switching processing. In a hot standby system, system states of each server are generally classified into three states, namely: a primary system state where services are actually provided; a standby state where services are not provided but processing can be undertaken immediately when a fault occurs in the primary system; and an offline state meaning a faulty state.

Each of the system switching control units 1100a, 2100a sends “keep alive” messages at regular intervals, and the other system switching control programs 1100a, 2100a receives those “keep alive” messages. When a fault occurs in the primary server (1000), no more “keep alive” message is sent from the primary server. At that time, the system switching control program 2100 of the standby server 2000 detects that a fault occurred in the primary server 1000, and performs the below-mentioned hot standby switching control.

In accordance with a management table 1295, 2295, each access control program 1200a, 2200a controls modes of access requests to a specific volume accessed by the application program 1410a, 2410a. Here, as the access requests, may be mentioned a read request, a write request, a file open request, and a file close request, for example. Further, the modes of the access requests mean modes of permission and inhibition of issuing access requests to the device driver 1400a, 2400a. For example, it is possible to consider the following modes, namely: a mode in which both read and write are permitted or (hereinafter, “or” is symbolized by “/”) inhibited; and a mode in which read is permitted/inhibited while write is inhibited/permitted. Further, it is possible that volumes constituting the shared disk unit 3000 may be grouped and a unique group ID is assigned to each group so that access requests are regulated in terms of a group.

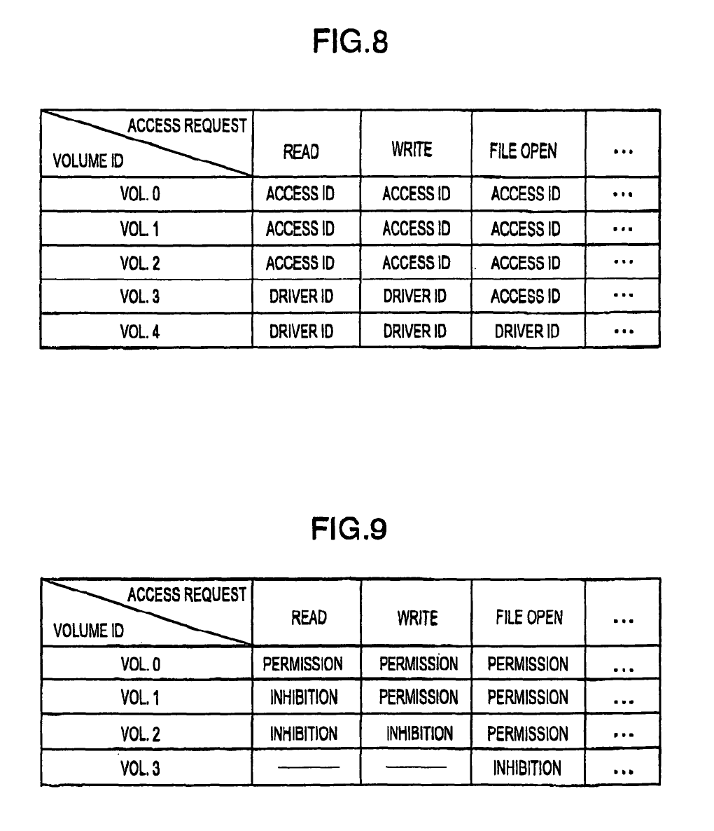

Based on an access request issued by the application program 1410a, 2410a and a device switch table shown in FIG. 8, the OS 1300a, 2300a specifies the issue destination of the access request. The device switch table is a table indicating an issue destination of au access request for each combination of a volume ID of an access request destination and a mode of an access request. As an access request destination, the device switch table originally indicates an address (a driver ID in FIG. 8) of a device driver 1400a, 2400a. However, with respect to a combination of a volume ID and a mode of an access request registered by an access mode registration program 1210, 2210, the device switch table indicates an address (an access ID in FIG. 8) of an access control program 1200a, 2200a, as described below.

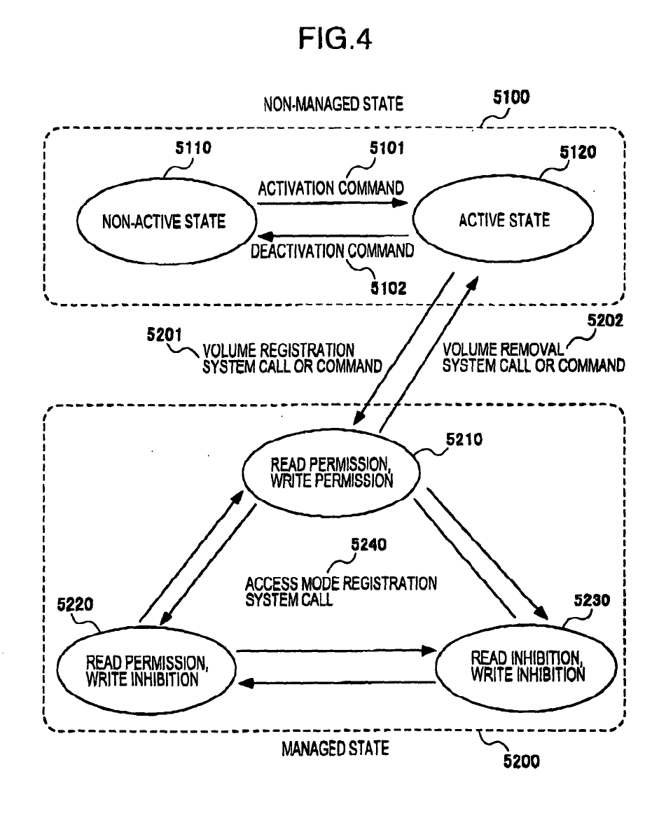

Further, each OS 1300a, 2300a issues an activation command/deactivation command to the device driver 1400a, 2400a to realize an active state/non-active state. The console 4000 can receive an activation command/deactivation command inputted by an operator. Details of the active state/non-active state will be described below, referring to FIG. 4.

Each of the device drivers 1400a, 2400a acquires disk configuration information and performance information for each component inside the disk, generates a translation map indicating which physical area inside the disk an access request is assigned to, and retains the translation map.

When a device driver 1400a, 2400a receives an access request from the OS 1300a, 2300a or the access control program 1200a, 2200a, then, the device driver 1400a, 2400a assigns the access request to a physical area inside the disk based on the access request, the disk configuration information, and the performance information for each component inside the disk, and issues the access request to the shared disk unit 3000.

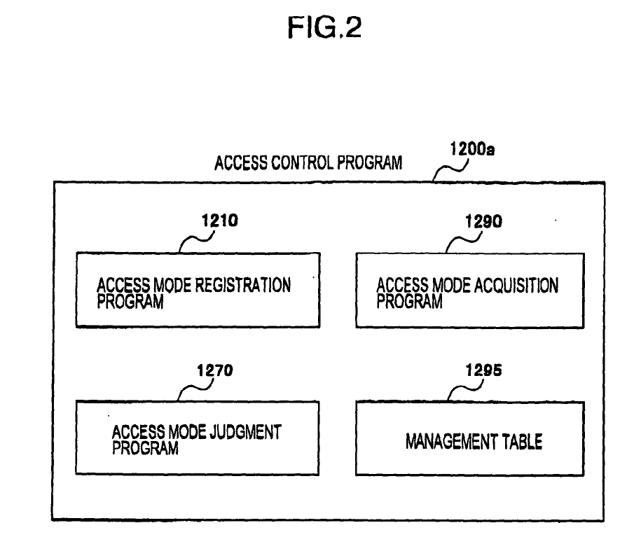

FIG. 2 is a block diagram showing a configuration of each access control program 1200a, 2200a.

Each access control program 1200a, 2200a comprises the accede mode registration program 1210, 2210, an access mode acquisition program 1270, 2270, an access mode judgment program 1290, 2290, and the management table 1295, 2295.

Th access mode registration programs 1210, 2210 registers/deletes a volume ID into/from the management table 1295, 2295, and registers/changes a mode of access requests for each volume ID registered. When a new volume is defined or a physical disk is added to thc shared disk unit 3000, the access mode registration programs 1210, 2210 can receive a volume ID and its mode of access requestL through the console 4000. When a group ID is given to a plurality of volumes, then, it is possible to register/delete volumes in terms of a group and to register/change a mode of access requests with respect to a group of volumes.

In response to an inquiry from the console 4000 or the processor 1500, 2500, the access mode acquisition program 1270, 2270 returns a mode of access requests with respect to a designated volume or group to the console 4000. The console 4000 outputs the received mode of access requests with respect to that volume or group.

Based on an access request from the OS 1300a, 2300a and the management table 1295, 2295, the access mode judgment program 1290, 2290 judges whether the access request should be issued to the device driver 1400a, 2400a. For example, when an access request is directed to a volume to which read is permitted/inhibited, an access from a device driver 1400a, 2400a is permitted/inhibited. When an access request is directed to a volume to which write is permitted/inhibited, an access to a device driver 1400a, 2400a is permitted/inhibited. Further, when an access request is directed to a volume that does not permit any access mode, then, accesses to and from a device driver unit 1400a, 2400a are inhibited.

As shown in FIG. 9, each of the management tables 1295, 2295 is a table showing a mode of an access request for each combination of a volume ID and an access request. When a group ID is given to a plurality of volumes, it is possible to record modes of access requests for each group. Registration into a management table 1295, 2295 can be performed with respect to each combination of a volume ID and an access request directed to that volume ID. In the example of FIG. 9, with respect to the volume ID of Vol. 3, a mode of a file open access request is registered, while modes of read and write requests are not registered (as shown by “-” in FIG. 9). Further, the device switch table shown in FIG. 8 shows the volume ID of Vol. 4 while the management table shown in FIG. 9 does not register a mode with respect to Vol. 4. Although FIG. 9 registers both cases of permission and inhibition as a mode of an access request, it is possible to register only the case of inhibition.

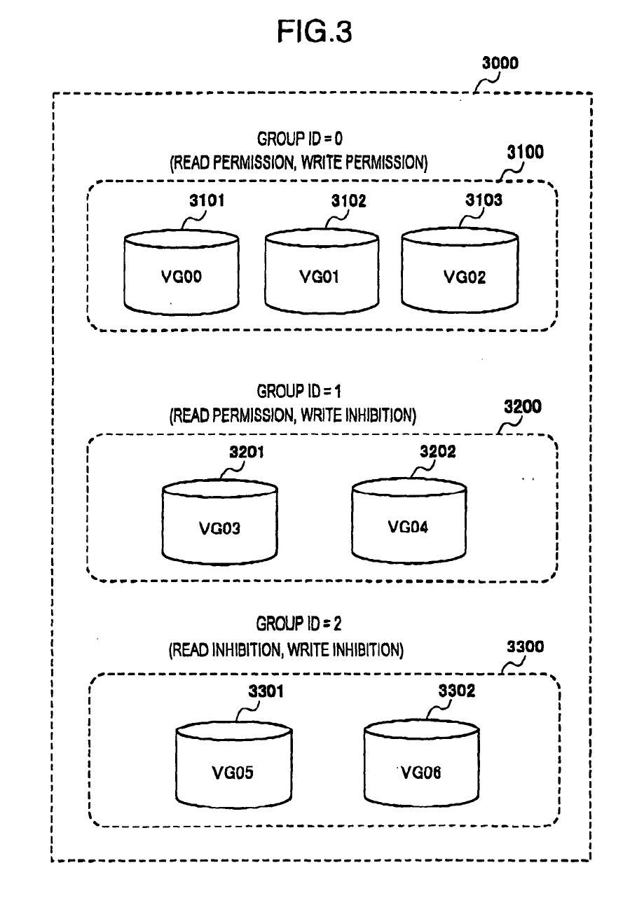

FIG. 3 is a diagram showing a configuration of the shared disk unit 3000.

In the shown example, seven volumes VG00 3101, VG01 3102, VG02 3103, VG03 3201, VG04 3202, VG05 3301 and VG06 3302 are classified into three groups assigned with IDs 0-2, respectively, and modes of access requests are set for each group. Of course, ID may be assigned to each volume.

With respect to the group 3100 having the group ID=0, read and write are permitted, and read and write are performed as usual.

With respect to the group 3200 having the group ID=1, write is inhibited. Thus, read processing is performed as usual, while write ends in failure.

With respect to the group 3300 having the group ID=2, both read and write are inhibited, and read/write processing fails.

FIG. 4 is a diagram showing state transition of a volume.

States of a volume are classified into a non-managed state 5100 and a managed state 5200.

The non-managed state 5100 is further classified into an active state 5120 and a non-active state 5110.

Now, transition procedures between the active state 5120 and the non-active stale 5110 will be described.

First, a transition procedure from the non-active state 5110 to the active state 5120 will be described.

In the non-active state 5110, when a device driver 1400a, 2400a receives an activation command from the OS 1300a, 2300a, then, the device driver 1400a, 2400a makes a request to the shared disk unit 3000 for the disk configuration information and performance information. Receiving the information, the device driver 1400a, 2400a generates a translation map that indicates a physical area assigned to each volume, based un the disk configuration information and performance information, and stores the generated map in the memory 1600, 2600. As a result, when the device driver 1400a, 2400a receives an access request, the device driver 1400a, 2400a can issue the access request to the shared disk unit 3000, based on the translation map generated. This state is called the active state 5120.

Next, a transition procedure from the active state 5120 to the non-active state 5110 will be described.

In the active state 5120, when a device driver 1400a, 2400a receives a deactivation command from the OS 1300a, 2300a, then, the device driver 1400a, 2400a discards the translation sap stored in the memory 1600, 2600. As a result, even when the device driver 1400a, 2400a receives an access request, the device driver 1400a, 2400a can not issue the access request to the shared disk unit 3000. This state is called the non-active state 5110.

Now, transition procedures between the non-managed state 5100 and the managed state 5200 will be described.

First, a transition procedure from the non-managed state 5100 to the managed state 5200 will be described. An access mode registration program 1210, 2210 registers a volume ID and a mode of access requests for that volume ID, which are designated by the console 4000, into the management table 1295, 2295. Further, the access mode registration program 1210, 2210 writes the address of the access mode registration program 1210, 2210 into an access request destination address corresponding to the volume ID and mode of access requests for that volume ID registered in the management table 1295, 2295. As a result, when the OS 1300a, 2300a receives an access request that is directed to a volume registered in the management table 1295, 2295 and belongs to the registered access request made for that volume, then, the OS 1300a, 2300a can issue the received access request to the access mode registration program 1210, 2210. Further, the access mode registration program 1210, 2210 can control an issue of the received access request to the device driver 1400, 2400, according to the management table 1296, 2295.

This state in which an access mode registration program 1210, 2210 can control an issue of a received access request to the device driver 1400, 2400 is called the managed state 5200. To the contrary, the managed state 5200 can be made to transition to the non-managed state 5100 by removing a registered volume from a management table 1295, 2295.

In the present embodiment, the managed state 5200 is classified into a mode 6210 in which both read and write are permitted, a mode 6220 in which read is permitted/inhibited and write is inhibited/permitted, and a mode 6230 in which both read and write are inhibited.

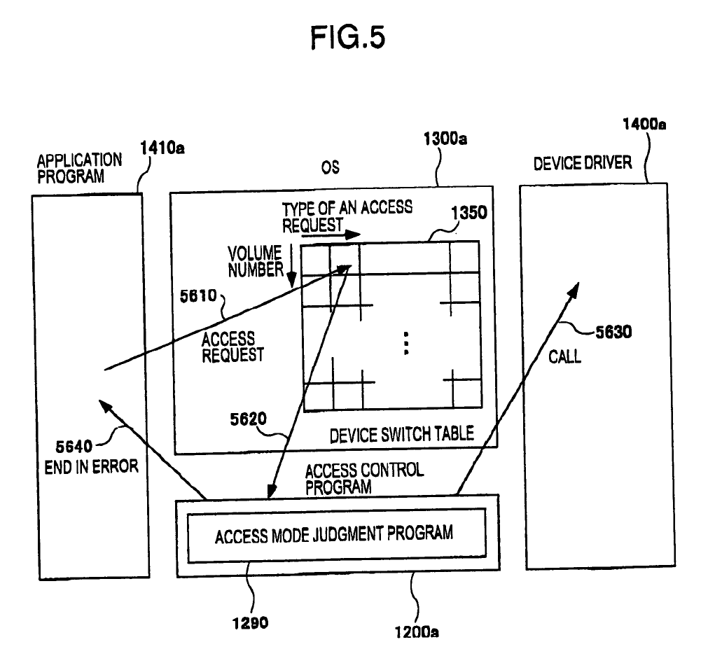

FIG. 5 is a diagram for schematically explaining access processing by the application program 1410a.

In the course of execution, the application program 1410a issues an access request such as a read request, a write request, or the like to the OS 1300 (Process 5610). At that time, the access request includes at least a volume ID and information indicating the type (such as read/write, ox the like) of the access request.

In response to the request from the application program 1410a, the OS 1300a determines an access destination based on the device switch table 1350, and issues the access request.

Here, when the access request is directed to a volume registered in the management table 1295, 2295, the address of the access control program 1200a, 2200a is registered in the device switch table 1350, and thus, the OS 1300a issues the received access request to thc access mode registration program 1210 (Process 5620).

The access mode judgment program 1290 judges whether the access request should be issued to the device driver 1400a, 2400a, based on the management table 1295, 2295. When the access request is directed to a volume registered in the management table 1295, 2295 as a volume to which an access is permitted, then, the access request is issued to the device driver 1400a, in the permitted access request mode (Process 5630). Here, the expression “in the permitted access request mode” means that, when the access request mode is permission/inhibition of read, then, read from the device driver 1400a is permitted/inhibited, and when the access request mode is permission/inhibition of write, then, write to the device driver 1400a is permitted/inhibited.

The device driver 1400a issues the access request to the volume requested by the access mode judgment program 1290, based on the translation map.

When the access mode judgment program 1290 receives the access request directed to a volume that is registered in the management table 1295 as a volume to which an access is inhibited, the access mode judgment program 1290 ends in an error (Process 5640). Here, it is possible that the access mode judgment program 1290 instructs the console to output a notification of the error, and the console outputs the error.

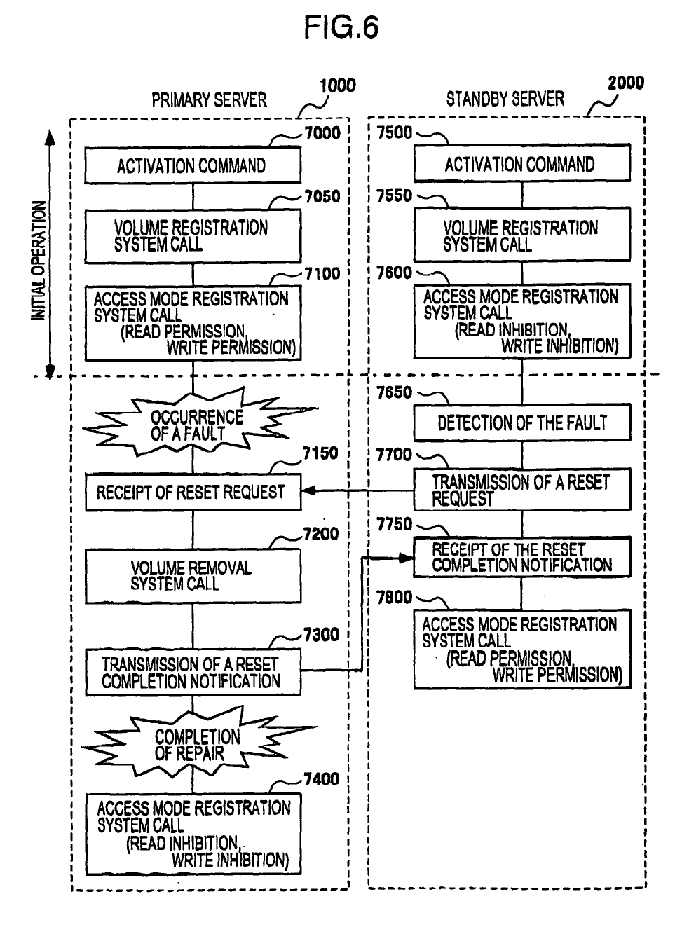

FIG. 6 is a diagram showing a flow of hot standby processing.

After starting the system, the access control program 1200a of the primary server 1000 instructs the OS 1300a to issue an activation command. The OS 1300a of the primary server 1000 issues an activation command 6101 to the device driver 1400a. The device driver 1400a sets the volumes constituting the shared disk unit 3000 in the active state 5120 (Step 7000).

Next, the access mode registration program 1210 registers volume IDs into the management table 1295, based on initial values (Step 7050). Here, the initial values are values indicating contents of the management table 1295, 2295, which are set by an operator in advance.

Further, based on the initial values, the access mode registration program 1210 registers a mode of access requests for each registered volume ID, into the management table 1295 (Step 7100).

On the other hand, after starting the system, the access control unit 2200a or the standby server 2000 instructs the OS 2300a to issue an activation command. The OS 2300a of the standby server 2000 issues an activation command to the device driver 2400a. The device driver 2400a sets thc volumes constituting the shared disk unit 3000 in the active state 5120 (Step 7500).

Next, the access mode registration program 2210 registers the specific volume IDs into the management table 2295, based on the initial values (Step 7550).

Further, the access mode registration program 2210 registers access modes of the registered volume IDs into the management table 2295 such that read and write from and to each volume ID are inhibited (Step 7600). Here, the access modes may be registered such that read is permitted and write is inhibited. In that case, in the standby server 2000, a read request by the application unit 2410a can be permitted.

Steps 7000, 7050 and 710U establish a primary system state in which the access mode judgment program 1290 of the primary server 1000 can issue a read/write access request (which has been issued by the application program 1410a of the primary server 1000) to the device driver 1400a, based on the management table 1295.

On the other hand, Steps 7500, 7550 and 7600 establish a standby state in which the access mode judgment program 2290 of the standby server 2000 issues neither a read access request nor a write access request (which has been issued by the application program 2410a of the standby server 2000) to the device driver 2400a.

Hereinabove, has been described initial operation that is executed after starting the system.

Nest, will be described operation in the case where a fault occurs in the primary server 1000.

In that case, the system switching control unit 2100a of the standby server 2000 detects the fault in the primary server 1000, based on disrupture of the “keep alive” messages (Step 7650).

On detecting the fault, the system switching control unit 2100a of the standby server 2000 issues a reset request to the primary server 1000 (Step 7700).

The system switching control unit 1100a of the primary server 1000 receives the reset request issued by the system switching control unit 2100a of the standby server 2000 (Step 7150).

Receiving the reset request, the system switching control unit 1100a of the primary server 1000 issues a system call 5202 to the access mode registration program 1210 so as to establish the offline state. Receiving the system call 5202, the access mode registration program 1210 changes the modes of the volume IDs registered in the management table 1296 such that read and write are inhibited. As a result, the primary system state is switched to the offline state in which the access mode judgment program 1290 of the primary server 1000 issues neither a read access request nor a write access request (which has been issued by the application program 1410a of the primary server 1000) to the device driver 1400a (Step 7200).

Here, it is possible that, when the system switching control program 1100a of the primary server 1000 receives the reset request, the system switching control program 1100a instructs the OS 1300a of the primary server 1000 to issue a deactivation command to the device driver 1400a. In that case, on receiving the deactivation command from the OS 1300a, the device driver 1400a discards the translation map stored in the memory 1600. As a result, even when the device driver 1400a receives an access request, the device driver 1400a can not issue the access request to the shared disk unit 3000, and thus the offline state is established. Further, the offline state may be established when the primary server 1000 is repaired from the fault, by issuing a volume activation command 5101 to make a transition from the non-active state 5110 to the active state 5120, similarly at the starting of the system.

Next, the system switching control program 1100a sends a reset completion notification, which indicates switching of the primary server 1000 to the offline state, to the standby server 2000 (Step 7300).

When the primary server 1000, in which the fault occurred, is repaired from the fault, then, based on the initial values, the access mode registration program 1210 registers a mode of access requests for each volume ID into the management table 1295, to make transition from the offline state to the standby state (Step 7400).

When the system switching control program 2100a of the standby server 2000 receives the reset completion notification from the primary server 1000 (Step 7750), then, the system switching control program 2100a issues a system call 5240 to the access mode registration program 2210 to switch into the primary system state. Receiving this system call, the access mode registration program 2210 changes the management table 2295, based on the initial values. This establishes the primary system state in which the access mode judgment program 2290 of the standby server 2000 issues an access request to the device driver 2400a based on the management table 2295 (Step 7800). Here, in addition to the system call 5240, the access mode registration program 2210 may receive the contents of the management table 1295 from the primary server 1000, and change the contents of the management table 2295 to take over the contents of the management table 1295 of the primary server 1000.

As described above, when a fault occurs in the primary server 1000, the access mode registration program 1210, 2210 changes the contents of the management tables 1295, 2295 to set the primary server 1000 and the standby server 2000 in the offline state and the primary system state, respectively. This realizes high speed switching of the shared disk unit 3000.

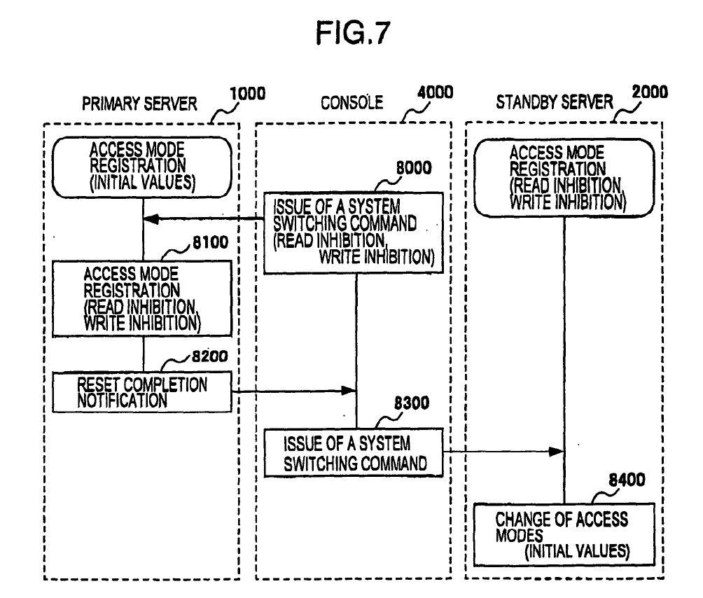

FIG. 7 is a diagram showing hot standby switching according to an instruction from the console 4000.

Here, it is assumed that, in the primary server 1000, the access mode registration program 1210 has already registered volume IDs and a mode of access requests for each volume ID, based on the initial values, in Steps 7000, 7050 and 7100. Further, it is assumed that, in the standby server 2000, the initial operation after the starting of the system has been executed in Steps 7500, 7550 and 7600.

When the console 4000 receives a hot standby switching command from an operator, then, the console 4000 issues a system switching command to the primary server 1000 (Step 8000).

When the primary server 1000 receives the system switching command, then, by means of the access mode registration program 1210, the primary server 1000 changes the modes of volume IDs registered in the management table 1295 such that read and write are inhibited. As a result, the access mode judgment program 1290 of the primary server 1000 issues neither a read access request nor a write access request (which has been issued by the application program 1410a of the primary server 1000) to the device driver 1400a. Thus, the primary server 1000 is switched to the offline state (Step 8100). Here, it is possible that, when the primary server 1000 receives the system switching command, then, by means of the access mode registration program 1210, the primary server 1000 deletes the volume IDs registered in the management table 1295. Thus, the volumes make a transition to the non-managed state, and thereby, the primary server 1000 is switched to the offline state. Further, it is possible that, when the primary server 1000 receives the system switching command, then, the primary server 1000 makes a transition to the non-active state, and thereby, switches to the offline state.

When the primary server 1000 switches to the offline state, the primary server 1000 sends a reset completion notification to the console 4000 (Step 8200).

Receiving the reset completion notification, the console issues a system switching command to the standby server 2000 (Step 8300).

Receiving the system switching command, the access mode registration program 2210 of the standby server 2000 rewrites the contents of the management table 2295 based on the initial values (Step 8400).

Here, it is possible that, together with the system switching command, the contents of the management table 1295 held by the primary server 1000 are sent to the standby server 2000, and the standby server 2000 changes the management table 2295 based on the contents of the management table 1295 held by the primary server 1000.

As a result, it is possible to change the system that accesses the shared disk unit 3000, and thc standby server 2000 can take over the processing of the primary server 1000.

The above-described embodiment employs the configuration where the access control programs 1200a, 2200a are provided separately from the device drivers 1400a, 2400u and the OS 1300a, 2300a.

Differently from the above embodiment, the access control programs 1200a, 2200a may be placed within the respective OS 1300a, 2300a. In that case, each access mode registration program may perform registration and deletion not in the management table but in the device switch table, so that the management tables are integrated with the respective device switch tables.

Or, the access control programs 1200a, 2200a may be placed within the respective device drivers 1400a, 2400a. In that case, the management tables may be integrated with the respective translation maps mentioned above.

As the modes of access requests, the above-described embodiment refers to permission/inhibition of read/write. However, as the modes of access requests, permission/inhibition of file open/file close can be similarly controlled.

As described above, the present invention can provide a technique of executing hot standby switching processing at high speed.

What is claimed is:

1. A server system comprising a plurality of servers that can be each operated as a primary system and a standby system by system switching, and a shared disk unit for storing data accessed by said plurality of servers, wherein:
each or said plurality of servers comprises:
an application means;
a driver means that: acquires information un a configuration inside said shared disk unit after starting of said system; and, based on said configuration information, sets said shared disk unit in an active state in which an access request to said shared disk unit can be sent; and, when the driver means receives an access request to said shared disk unit, sands said access request to said shared disk unit; and
an access control means that: judges whether an access request issued by said application means should be sent, based on a management table indicating inhibited types of access requests for each access destination; and sends said access request to said driver means when said access request is not inhibited for an access destination of said access request.

2. The server system according to claim 1, wherein:
when a fault occurs in a server operating as the primary system, then the access control means of said server registers in said management table such that an access request of said application means to any access destination is inhibited.

3. The server system according to claim 1, wherein:
said server system further comprises a console for sending said plurality of servers a system switching command inputted by an operator; and
when a server operates as the primary system and the access control means of said server receives said system switching command, then, said access control means registers in said management table such that an access request of said application means to any access destination is inhibited.

4. The server system according to claim 2 or 3, wherein:
said access control means registers in said management table such that, as said access request, at least write is inhibited.

5. The server system according to claim 1, wherein:
said management table indicates an inhibited read and/or write access request fox each access destination; and
said access control means judges, based on said management table, whether a read or write access request issued by said application means should be sent, and sends the read or write access request to said driver means when said access request is directed to an access destination for which the read or write access request is not inhibited.

6. The server system according to claim 1, wherein:
said management table indicates an inhibited file open and/or file close access request for each access destination; and
said access control means judges, based on said management table, whether a file open or file close access request issued by said application means should be sent, and sends the file open or file close access request to said driver means when said access request is directed to an access destination for which the file open or file close access request is not inhibited.

7. The server system according to claim 1, wherein:
said server system further comprises a console for sending said plurality of servers a command for registering, deleting or changing inhibited access requests for each access destination, with said command being inputted by an operator; and
when said access control means receives said command, then, according to said command, said access control means registers, deletes or changes an identifier specifying an access destination and types of access requests inhibited for said access destination, in said management table.

8. The server system according to claim 1, further comprising:
a console for sending each of said plurality of servers a command that is inputted by an operator and that requests contents of the management table, and for outputting the contents of the management table received from the server in question.

9. A server that can operate as a primary system and a standby system by system switching, comprising:
an application means;
a driver means that: acquires, after starting of said server, information on a configuration inside a shared disk unit whose data are shared by a plurality of servers; and, based on said configuration information, sets said shared disk unit in an active state in which an access request to said shared disk unit can be sent; and, when the driver means receives an access request to said shared disk unit, sends said access request to said shared disk unit; and
an access control means that: judges whether an access request issued by said application means should be sent, based on a management table indicating inhibited types of access requests for each access destination; and sends said access request to said driver means when said access request is not inhibited for an access destination of said access request.

10. A storage medium storing a program for making a server operate as a primary system and a standby system by system switching, with said server being provided with a driver means that receives an access request to a shared disk unit whose data are shared by a plurality of servers and that, on receiving said access request, sends said access request to said shared disk unit, wherein: said program makes said server execute:
processing of acquiring, after starting of said server, information on a configuration inside said shared disk unit, and of instructing said driver means based on said configuration information to set said shared disk unit in an active state in which an access request to said shared disk unit can be sent, and
processing of judging whether an access request issued by execution of another application program should be sent, based on a management table indicating inhibited types of access requests for each access destination, and of sending said access request to said driver means when said access request is not inhibited for an access destination of said access request.

11. A storage medium storing a program for making a server operate as a primary system and a standby system by system switching, wherein:
said program makes said server execute:
processing of acquiring, after starting of said server, information on a configuration inside a shared disk whose data are shared by a plurality of servers, and of setting, based on said configuration information, said shared disk unit in an active state in which an access request to said shared disk unit can be sent; and
processing of judging whether an access request issued by execution of another application program should be sent, based on a management table indicating inhibited types of access requests for each access destination, and of sending said access request to said shared disk unit when said access request is not inhibited for an access destination of said access request.

12. The storage medium according to claim 11, wherein:
said program further functions as an OS in said server.

13. A method of access control in a server that can operate as a primary system and a standby system by system switching, comprising:
processing of acquiring, after starting of said server, information on a configuration inside a shared disk whose data are shared by a plurality of servers, and of setting, based un still configuration information, said shared disk unit in an active state in which an access request to said shared disk unit can be sent; and
processing of judging whether an access request issued by execution of another application program should be sent, based on a management table indicating inhibited types of access requests for each access destination, and of sending said access request to said shared disk unit when said access request is not inhibited for an access destination of said access request.
